(19) United States
(12) Patent Application Publication
(10) Pub. No.: US 2011/0149025 A1
(43) Pub. Date: Jun. 23, 2011

(54) Three-Dimensional Imaging Method, Installation Implementing Said Method, Method for Configuring Such an Installation, Computer Programme Implementing Said Method

(76) Inventors: David Brasse, Haegen (FR); Bernard Humbert, Strasbourg (FR); Nicolas Rudolf, Hoenheim (FR); Benoit Speckel, Strasbourg (FR); Denis Staub, Strasbourg (FR)

(21) Appl. No.: 11/886,287

(22) PCT Filed: Mar. 14, 2006
(86) PCT No.: PCT/FR2006/000561

§ 371 Date: Jun. 16, 2008

(30) Foreign Application Priority Data
Mar. 15, 2005 (FR) 0502564

(51) Int. Cl. H04N 13/02

(52) U.S. Cl. 348/43; 348/E13.074

(57) ABSTRACT

The invention concerns a method for three-dimensional imaging of a volume to be imaged executed by several computers connected in parallel: an emitting machine (13c) transmits to a network enabling transfer rates at least equal to 100 megabits per second (Mb/s), data delivered by an acquisition system corresponding to a set of projections of the volume, acquired in accordance with various incidences. The data are duplicated inside the network towards a plurality of processing machines (14a, 14b), which receive each the received data. In each processing machine the correspondence between the received data and the transmitted data is ascertained. Each processing machine processes the data to reconstruct a fraction of the three-dimensional image of the volume to be imaged. At the end of the acquisition, and hence of the inline real-time reconstruction, a dedicated machine collects the set of fraction of images to reconstitute the three-dimensional image. The resulting improved systolic processing compared to the known multicast MPI (message passing interface) enables the speed, reliability and flexibility of the real-time tomographic restitution of moving small laboratory animals to be increased at a lower cost.

This present invention relates to three-dimensional imaging methods, to installations implementing such method, to methods for configuring such installations, and to computer programs implementing these methods.

In particular, the invention relates to a three-dimensional imaging method of a multiplicity of images representing a volume to be imaged, acquired from different incidences by a sensor, such as the projection of a three-dimensional volume from an incidence onto a measuring sensor for example.

It is possible, in particular, to use two-dimensional images acquired by a plane sensor.

One can mention two large categories of installation implementing these methods. A first category consists of a dedicated machine with dedicated hardware, developed for each application. Such installations are rather inflexible, and in particular are too specific to the sensor, and to the algorithm used, to allow them to be used directly with another type of sensor or another algorithm. As a consequence, these installations are very costly, and are therefore intended for equipment that can guarantee high profitability (medical imagery of the human body in particular).

A second large category consists of groups of PCs connected in a network. These PCs operate in parallel. In this case, it can be arranged, for example, that each PC operating in parallel receives a sub-set of the projections from the acquisition device, and independently reconstructs the contribution of this sub-set of the projections to the entire volume, and then that one adds together the volumes obtained by each PC and each corresponding to a sub-set of projections. Alternatively, it is possible to transmit the entirety of the projections to each PC, with each PC being assigned to the reconstruction of a portion of the volume to be imaged, these portions then being assembled. In these methods, the speed of the computation is directly linked to the ability of the network to transmit, rapidly and reliably, a large quantity of data, and to the number of machines.

The increase in the speed of reconstruction is necessarily conditional upon an increase in the number of machines, which in its turn essentially requires an increase in the network data speed. It is this criterion that then becomes the limiting factor of the speed of reconstruction of the three-dimensional image.

Correct management of the information (in particular of the data coming from the sensor) then becomes a major factor in the improvement of existing methods for the reconstruction of three-dimensional images.

Data distribution techniques, allowing a reduction in the volume of the data flows during the diffusion to many receivers, are already used on the Internet, in particular for the multimedia applications, and are grouped under the title of “multicast”.

Only the use of the UDP protocol allows the simultaneous distribution of data to a certain number of receivers. Nevertheless, the transmission in non-connected mode effected by this protocol does not provide a guarantee that the data transmitted have been totally received by all the receivers. This defect is not really constraining for the multimedia applications, since it is not essential to receive the entirety of the data in this type of application.

In order to ensure the actual reception of all of the data at all of the receivers, the alternative consists of using the existing “multicast” methods for the standard networks implementing the library of Message Passing Interface (MPI) functions. The latter necessitate several successive stages during which several point-by-point transmissions using the TCP/IP protocol are effected. Thus, in the course of a first stage, a transmitting machine sends the data to a first receiving machine. In the course of a second stage, the transmitting machine and the first receiving machine each transmits the data to a new receiving machine. One then proceeds in this way, with each receiving machine becoming a transmitting machine to the following stage. The transmission of the data to 5 machines thus requires three stages, to 9 machines requires 4 stages, and so on.

Although such a transfer of information has advantages, which renders it appropriate to its current use, in a reconstruction system with no time constraint for example, it is not suitable to be used to rapidly obtain a three-dimensional image of a volume to be imaged through the use of a multiplicity of processing machines. In fact, for such large data flows, it is essential to be able to supply the necessary data to all the processing machines as soon as possible, if one wishes to tend toward imagery in real time. For example, US 2003/206,609, presenting a parallel computation employing two machines, was already describing “data bottlenecks”.

In order to overcome these drawbacks, the invention proposes a method for three-dimensional imaging of a volume to be imaged 4, which includes at least the following:

a) a transmission stage during which at least one transmitting machine transmits over a network that provides transfer rates at least equal to 100 Megabits per second (Mb/s), intended for a multiplicity of processing machines, transmitted data corresponding to a projection of the said volume, acquired from a given incidence,

b) a reception stage during which each processing machine receives the received data relating to the transmitted data,

the said received data being obtained, from the data transmitted, by duplication within the network intended for each processing machine,

c) a checking stage during which it is ensured, for each processing machine, that the data do indeed correspond to the data transmitted, and

d) a processing stage during which each processing machine processes the said received data in order to reconstruct a three-dimensional image of the volume to be imaged.

As a result of these arrangements, the network performs the virtually-simultaneous transfer of all of the data to each processing machine, which is then able to process the information in order to reconstruct the three-dimensional image of the volume to be imaged. One thus has a method that is both fast and reliable.

In preferred embodiments of the invention, it is possible, where appropriate, to also have recourse to either or both of the following arrangements:
in the course of stage (a), the transmitting machine sends out the transmitted data in the form of data blocks each with a multiplicity of datagrams, and

in which in the course of the stage (c),

c1) each processing machine sends out, to the transmitting machine, a request for re-transmission of the datagrams missing from the data block,

c2) the transmitting machine lists all the datagrams missing from the data block, and

c3) the transmitting machine sends out all the datagrams missing from the data block intended for all of the processing machines;
stage (a) is repeated with other data corresponding to a projection of the said volume, with stage (a) being repeated only after a positive result from the said checking stage;
stages (a) to (d) are repeated for a multiplicity of data corresponding to a multiplicity of projections of the said volume, each acquired at a given incidence, the said incidences being distinct two by two;
in the course of the reception stage, in each processing machine, one receives received data corresponding at least to a part of the said transmitted data,

and, in the course of the checking stage, each processing machine ensures that the received data corresponds to the transmitted data in the following manner:

each processing machine estimates a reception quality of the received data, and sends out, in the direction of a transmission checking machine, an acknowledgement of receipt relating to the reception quality of the said received data, and

the said transmission checking machine waits for the said acknowledgement of receipt from each of the processing machines;
the said data include a predetermined number of data datagrams,

in the course of the checking stage, each processing machine sends out the said acknowledgement of receipt only after reception of the said predetermined number of datagrams (the predetermined number of datagrams can be configurable by the user);
in each processing machine, the said transmitted data correspond to the said first received data and to unreceived data, then in the course of the checking stage, the said processing machine sends out a request for re-transmission of the unreceived data, and in the course of a re-transmission stage, at least the said unreceived data are re-transmitted over the said network;
before the distribution stage, the imaging method also includes a stage (z) for the establishment of communications, during which each processing machine sends out to the network a query to be a receiver of the distribution of the said transmitted data, with the said transmitted data being duplicated within the network, in the course of the distribution stage, intended for the processing machines that have transmitted a request to be a receiver of the distribution of the data transmitted;

the method also includes an acquisition stage (e), prior to the distribution stage, during which a sensor acquires raw data corresponding to the said projection;
the acquisition stage is triggered in accordance with a signal transmitted by the volume to be imaged;
the method also includes a pre-processing stage (f) between the said acquisition stage and the said transmission stage, during which the said transmitted data are generated by applying to the raw data a corrective pre-processing that takes account of the physical characteristics of the acquisition;
in the course of the processing stage, each processing machine respectively processes a processing volume corresponding to a fraction of the volume to be imaged;
in the course of the processing stage, each processing machine retro-projects the said received data in the said processing volume in order to obtain a retro-projected three-dimensional image corresponding to the said projection, and add the said three-dimensional image to a prior partial result obtained from prior projections of the volume to be imaged; (Of course, during the acquisition of the first projection, the prior partial result to which the three-dimensional image is added is zero).
the method also includes an assembly stage (g) during which a collection machine receives from the said processing machines the said respective processing volumes and assembles the said processing volumes to reconstitute a three-dimensional image of the volume to be imaged.

According to another aspect, the invention relates to a computer program that includes program codes for the implementation of such a three-dimensional imaging method, when it is executed on at least one programmable machine.

According to another aspect, the invention relates to an installation for the three-dimensional imaging of a volume to be imaged, which includes at least:
at least one transmitting machine, designed to transmit, over a that supports transfer rates at least equal to 100 Megabits per second, transmitted data corresponding to a projection of the said volume acquired from a given incidence, intended for a multiplicity of processing machines,
the said processing machines, each designed to accept received data relating to the transmitted data,

the said received data being obtained, from the transmitted data, by duplication within the network intended for each processing machine,

the said installation being designed to ensure that, for each processing machine, the received data correspond to the transmitted data,

each processing machine being designed to process the said received data in order to reconstruct a three-dimensional image of the volume to be imaged.

In preferred embodiments of this present installation, it is also possible to provide for any of the following arrangements

each transmitting machine is designed to transmit the transmitted data in the form of data blocks, each with a multiplicity of datagrams, in which each processing machine is designed to transmit, to the transmitting machine, a request for re-transmission of the datagrams missing from the data block,

the transmitting machine is designed to list all the datagrams missing from the block of received data, and to transmit all the datagrams missing from the data block, for reception by all of the processing machines;
each of the said processing machines is designed to perform processing of the said first data, in order to reconstruct a three-dimensional image of a respective processing volume corresponding to a fraction of the volume to be imaged;

the installation also includes a collection machine, intended to be connected to each processing machine over the network, with the said collection machine being designed to receive the said three-dimensional images of respective processing volumes from each processing machine, and to assemble these so as to form a three-dimensional image of the volume to be imaged;
the installation also includes at least one pre-processing machine intended to be connected to at least one transmitting machine over the network, with the said pre-processing machine being designed to apply a pre-processing function to a projection in order to generate data to be transmitted, and to transmit the said data to be transmitted to the said transmitting machine;
the said pre-processing machine is designed to receive a projection from a sensor at a sensor data speed, and the data speed of the network is chosen in accordance with the said sensor data speed;
the installation also includes a radiation source designed to transmit radiation in the direction of the volume to be imaged, and a sensor designed to detect the said radiation after its passage through the volume to be imaged, and to generate the said projection from it;
the said machines are PC central units.

According to another aspect, the invention relates to a method for the configuration of a group of machines in an installation for the three-dimensional imaging of a volume to be imaged, which includes at least:
at least one transmitting machine, designed to transmit, over a network that supports transfer rates at least equal to 100 Megabits per second, intended for a multiplicity of processing machines, transmitted data corresponding to a projection of the said volume acquired from a given incidence,
the said processing machines, each designed to accept received data relating to the transmitted data,

the said received data being obtained from the transmitted data by duplication within the network intended for each processing machine,

the said installation being designed to ensure that, for each processing machine, the received data correspond to the transmitted data,

each processing machine being designed to process the said received data in order to reconstruct a three-dimensional image of the volume to be imaged,

the said configuration method including a configuration stage during which each machine of the said group of machines is assigned to a function chosen from a group of functions that includes at least a transmission function, a processing function and a reception function.

In certain embodiments of this configuration method, it is also possible to provide that:
the transmission function includes a function for transmission of the transmitted data in the form of data blocks, each with a multiplicity of datagrams, in which the reception function includes a function for transmission to the transmitting machine of a request for re-transmission of the datagrams missing from the data block, and in which the transmission function also includes a function for listing all the missing datagrams and a function for transmission of all the missing datagrams intended for all of the processing machines;
the group of functions also includes a pre-processing function, and a collection and assembly function.

According to another aspect, the invention relates to a computer program that includes program codes for the implementation of such a configuration method, when it is executed on at least one programmable machine.

In order to be able to apply the processing to the data, it can be necessary to pre-process them in order to take account of the special features of the sensor and/or to filter and parasitic components detected. In document US 2003/206,609, and in a conventional manner, the acquired raw data are stored in non-volatile memory (on a disk, for example) before being subjected to this pre-processing. This intermediate stage also consumes time and resources, since it is then necessary to read the raw data from the non-volatile memory, and to transmit them to a pre-processing machine.

The invention also relates to an acquisition machine that includes a computer and a device for connection to a sensor that includes an output delivering, to the said computer, raw data representing a projection detected by the said sensor, where the said computer includes:
an input/output daughter card that includes a pre-processing processor programmed to apply pre-processing to the said raw data output from the said connection device, in order to generate pre-processed data,
a random-access memory, and
a bus connecting the said pre-processing processor and the said random-access memory,
the said computer being designed to write, to the said random-access memory, the said pre-processed data coming from the processor.

Such an acquisition machine is used to apply “on the fly” pre-processing to the raw data output from the sensor, before writing the pre-processed data to random-access memory. As a consequence, the resources that were previously dedicated to pre-processing of the data can then be used directly for reconstruction. For the same number of machines connected to the network as the above process, it is thus possible to maximise the number of machines connected in parallel for retro-projection.

According to preferred embodiments of this acquisition machine, it is also possible to provide for any of the following arrangements:

the computer also includes
a device for connection to the exterior, and
a processor designed to read the said pre-processed data from the said random-access memory, to apply to them another pre-processing function in order to generate data to be transmitted, and to write the data to be transmitted into the random-access memory of a transmitting machine via the said device for connection to the exterior;

the said pre-processing processor is a reconfigurable processor designed to be configured in accordance with the sensor.

Other characteristics and advantages of the invention will emerge in the course of the description that follows of one of its forms of implementation, given by way of a non-limiting example, with reference to the attached drawings.

On the drawings:

FIG. 1 is a schematic view of an imaging installation,

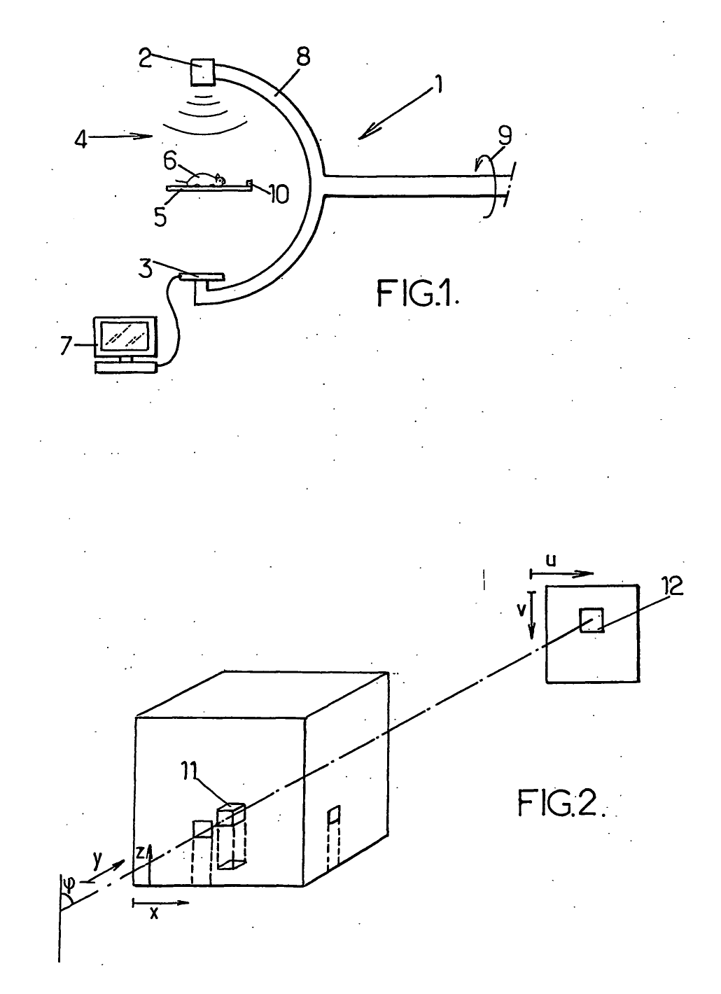

FIG. 2 is an explanatory diagram of the retro-projection of a pixel in a voxel,

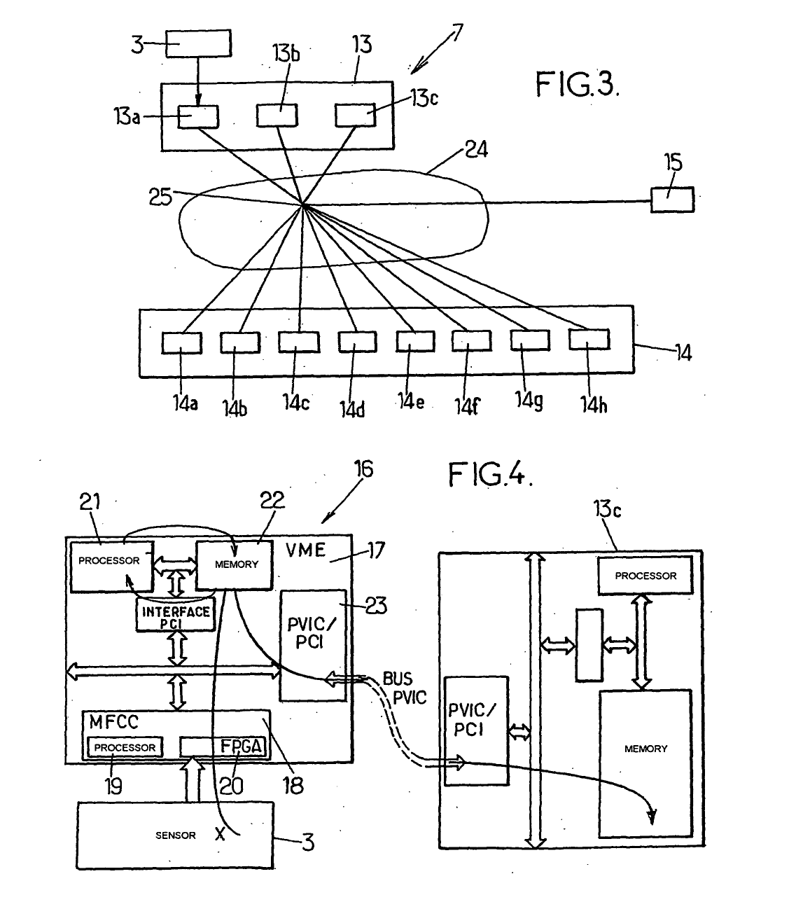

FIG. 3 is an explanatory diagram of the configuration of the installation of FIG. 1 according to a first embodiment, and

FIG. 4 is a detailed diagram of a second embodiment of the pre-processing part of the installation of FIG. 3.

On these different figures, the same references refer to identical or similar elements.

FIG. 1 is a schematic view of a three-dimensional imaging installation 1. The latter includes, in a conventional manner, a radiation source 2 and a sensor 3 placed on either side of a volume to be imaged 4 that can, for example, include a fixed support 5 on which is placed an object to be imaged 6.

By way of an example, the radiation source 2 is an X-ray source, such as, a Hamamatsu L860-01 tube micro source, for example, and the sensor 3 is a corresponding X-ray sensor, such as a CsI scintillator for example, coupled to photodiodes and distributed by Hamamatsu under serial number T7942. Nevertheless, other types of radiation/detector pairs could be used in the invention, such as in the context of imaging by the transmission of positions, or by monophotonic transmission, or other.

In order to take a projection of the object to be imaged 6, according to a first incidence, the radiation source 2 sends out radiation in the direction of the object to be imaged 6, and the traversing radiation is detected by the sensor 3, which, for example, is formed by a plane matrix of 2048×2048 elementary detectors. The radiation detected by each of the detectors of the sensor 3 is then read by a computerised system 7, which will be described below in greater detail, and which reconstitutes a three-dimensional image from the data read from the sensor 3.

In order to reconstruct a three-dimensional image of the object to be imaged 6, several plane projections of the object to be imaged 6 are acquired according to different incidences. In this regard, the radiation source 2 and the sensor 3 can be mounted on an arm 8 that is mobile in relation to the support 5, and capable, for example, of turning through 360° as represented by arrow 9 in FIG. 1. The rotation in question is effected step by step for example, and includes instants at which, with the arm remaining fixed, a projection of the volume to be imaged is acquired, and other instants at which the arm is moved to a later acquisition position. During the rotation of the arm, the transmission of the radiation by the radiation source 2 can be interrupted, so as to reduce the radiation to which the object to be imaged 6 is subjected. The rotation of the arm 9 can be controlled by the computerised system 7. In addition, its synchronisation can be predetermined or variable. For example, when the object to be imaged 6 is a small laboratory animal, it is possible to synchronise the “movement-acquisition” sequence in accordance with a physiological signal from the small animal to be imaged, such as its respiration or its heartbeat. For example, one is in possession of a sensor 10 designed to trigger acquisition on each exhalation of the small animal 6, in order that all the projections of the small animal 6 represent it in a given position corresponding to an end-of-exhalation position, and this is used to obtain a clear three-dimensional image of the object 6.

As explained in greater detail below, the raw data transmitted by the sensor 3 are not necessarily usable directly in order to reconstruct a three-dimensional image of good quality. As a consequence, it will be possible to apply to them a series of one or more preliminary methods in the computerised system 7. In order to construct the three-dimensional image, it is possible, for example, to use an algorithm of the Feldkamp type, in which the intensity in a voxel 11 at coordinates (x, y, z) is equal to a weighted sum of the projections obtained according to each incidence, referenced by its angle φ in relation to a reference position, such as the position shown in FIG. 2 for example, according to a formula of the type:

I(x,y,z)=Σφw(x,y,φ)·Pφ[u(x,y,φ),v(x,y,φ)],

in which:

w (x, y, φ) is a weighting factor applied to each projection P(u, v) and

P(u, v) is the intensity computed in the course of the preliminary processing for pixel 12 at coordinate (u,v) for the projection obtained according to the incidence characterised by the angle φ.

This computation is effected in each voxel of the three-dimensional image. These voxels can for example be to the number of 2.10⁸ voxels of 0.1 mm×0.1 mm×0.1 mm to cover the volume to be imaged and surrounding an entire small laboratory animal.

A first embodiment of a three-dimensional imaging installation is shown in FIG. 3. The computerised system 7 includes three groups of machines 13, 14, 15 connected together in a network 24 supporting a data transfer that is sufficient to match the data transfer rate output from the sensor 3. For example, the network supports transfer rates of the order of 100 Megabits per second (Mb/s), or preferably at least equal to 1 Gb/s, by implementing an Ethernet Gigabit technology. In this present example, all the machines are star-connected to an Ethernet Gigabit switch 25, such as a Catalyst 3750 for example, marketed by the Cisco Company.

The first group of machines 13 includes several machines 13a, 13b, 13c working in series, and each applying pre-processing to the raw data coming from the sensor 3. The second group of machines 14 includes a multiplicity of machines, namely 8 machines 14a, . . . , 14g, 14h for example, working in parallel, to effect retro-projections in accordance with the previously described Feldcamp algorithm. For the implementation of this stage, it can be arranged, for example, that from the data relating to the entirety of each projection, each machine 14a, . . . , 14h, known as a processing machine, reconstructs a separate portion of the volume to be imaged, and known as the processing volume. The partial volumes reconstructed by each processing machine are then transmitted to the third group of machines 15, which can include one or more viewing machines, which assembles the partial volumes to reconstitute a three-dimensional image of the complete volume to be imaged.

For each incidence, the data are subjected to the following processing:

The raw data are transmitted from the sensor 3 to the first machine 13a of the first group 13 at a rate, depending on the sensor selected and, in this present example of implementation, equal to 16 Megabytes per second (MB/s), thus corresponding to two projections possible per second. The first machine 13a of the first group 13 applies to the raw data a first preliminary method to correct the physical phenomena due to the acquisition. This pre-processing is configured, for example, in accordance with a preliminary stage for calibration of the sensor. Following this pre-processing, the data are transmitted, at a rate of 32 MB/s, due to passage from 16-bit integers to 32-bit floating point, to the second machine 13b of the first group 13. The latter can, for example, apply filtering to the data, by transformation of the acquired data into the Fourier space for example. The pre-processed data are transmitted to the third machine 13c of the first group 13 which is responsible for the distribution of the data to the processing machines of the second group 14.

The data stream in the first group of machines is buffered if necessary in the various machines, in order to allow for any variations in the data flow.

A multicast distribution of the data from the transmitting machine 13c is effected to all of the processing machines 14a, . . . , 14h in the second group 14. Each processing machine 14a to 14h is connected to the output from the switch. Each processing machine 14a to 14h) states that it is ready to participate in the reconstruction, by transmitting over the network a request to be one of the receivers of the data distribution. Alternatively, the transmission is effected in a “broadcast” to all of the machines in a closed network.

In order to achieve a rapid transfer of the data to each of the processing machines, it was necessary to develop a new library of functions that would allow the simultaneous or virtually simultaneous and reliable transfer of the data to all the processing machines. In fact, the multicast method of the MPI library used by default by the processing machines, does not actually effect a simultaneous transfer of the data to all of the processing machines. In fact, multicast under MPI functions in the following manner: in the course of a first stage, the data are transferred from the transmitting machine 13c to a first processing machine 14a. In the course of a second stage, the data are transmitted from each of the machines that have the data 13c, 14a to a machine that does not (such as 14b and 14c), and so on until all of the machines required to process data have retrieved them in memory. Such methods lead to overloading of the network that is incompatible with the objectives of reconstruction speed set by the invention.

The data are duplicated within the network, at the level of the switch, intended for all of the processing machines requiring to receive data. This allows a true simultaneity of the transfer of data to all of the processing machines 14a to 14h.

With the new developed library, a secure transfer protocol is created, since the three-dimensional reconstruction should be effected on the basis of all of the data processed.

To this end, a secure protocol is provided, operating in the following manner. The pre-processed data corresponding to the image are divided into data blocks, each with X numbered datagrams. This is based upon the user datagram protocol (UDP). The transmitting machine 13c sends out a data block composed of X datagrams. The UDP protocol ensures that a transmitted datagram, if received, is received in full. On the other hand, it does not guarantee that the entirety of the datagrams transmitted are received. Each processing machine 14a to 14h assures itself on the completeness of the received data. If the data block has been received completely, it returns a positive acknowledgement of receipt to the transmitting machine 13c, thus operating as a transmission checking machine. If the processing machine observes that a certain number of datagrams have not been received correctly, it sends out a request to the transmitting machine 13c for re-transmission of the missing datagrams.

If the transmitting machine 13c receive positive acknowledgements of receipt from all of the processing machines, it can commence a later transmission stage, to transmit the next data block to all of the processing machines. If some datagrams have not been received correctly by some processing machines, then the transmitting machine 13c lists all the datagrams to be re-transmitted, and re-transmits all these datagrams in the direction of all of the processing machines 14.

This stage can if necessary be repeated one or more times until a positive acknowledgement of receipt is obtained from each of the processing machines.

It is also possible to arrange that, if the transmitting machine observes that an excessive number of datagrams have to be re-transmitted, it re-transmits the entirety of the current data block to all of the processing machines.

A detailed communication example is described below. Each block of data, corresponding to a projection for example, is divided into X datagrams of 1500 bytes each, with the following structure:
an IP header as described in the standard, contained in 20 bytes,
a UDP header as described in the standard, contained in 8 bytes,
the number of the current projection, coded in 2 bytes,
the number of the UDP packet for the projection, coded in 2 bytes, and
useful data in 1468 bytes.

Each receiving machine includes a virtual processor continuously monitoring the network, except for a few moments when the processor in question is executing system functions. As a consequence, virtually the entirety of the datagrams for the given projection is going to be received by each receiving machine.

Following the transmission of the last datagram for the current data block, the transmitting machine switches to receive mode. Each receiving machine, after the reception of the last datagram or after receiving datagram number X, after a predetermined period of time, checks the number of datagrams received. It sends out a TCP message of acknowledgement of receipt of the data block, in the direction of the transmitting machine. This acknowledgement of receipt can be any of the following:
an acceptance of the complete projection, in the case where it has received the entirety of the datagrams for the current data block,
a request for retransmission of the complete data block, if it observes that a large number of datagrams have not been received,
a request for retransmission of the missing packets only. In this case, the receiving machine sends out, for the attention of the transmitting machine, following the TCP message of acknowledgement of receipt, a second TCP message, in the form of a bits table for example, indicating, for each packet, whether it is necessary (bit at zero) or not necessary (bit at 1) to re-send the packet in question.

On the basis of the reception of all of the acknowledgement of receipt messages coming from all of the receiving machines, the transmitting machine, for the data block in question, if there remains data to be retransmitted, re-transmits, by means of the protocol described above, all of the missing packets from the data block concerned. The redundant packets are filtered out by each receiving machine. Each receiving machine that has requested a retransmission again checks whether or not the missing packets are received, and the procedure described above can, where necessary, be implemented once again, until each receiving machine has sent out a positive acknowledgement of receipt for the data block concerned, for the attention of the transmitting machine.

The transmitting machine then passes on to transmission of the next data block.

It will be noted that the secure multicast distribution protocol that has just been described is designed to be implemented in the context of a tomographic reconstruction method, but can be used for any type of multicast data distribution method, or broadcast for a set of machines in a restricted network.

It is also possible to provide for consistent security in that, if the transmitting machine observes that it is too frequently required to re-transmit large volumes of data, it indicates to the user that it is necessary to intervene physically on one or more installations in the network, in order to replace a defective switch or receiver.

The data are written directly into random-access memory in each processing machine, so that the reconstruction can be effected rapidly.

When each processing machine has received the entirety of the data corresponding to a projection, it applies the Feldkamp algorithm to the projection received, to retro-project the latter in a processing volume assigned to this processing machine, and corresponding to a predetermined fraction of the total volume to be imaged. For each voxel, each processing machine adds, to a partial result obtained from the previous projections, the intensity value computed for this present-projection.

Finally, when all of the projections have been processed by the second group of machines, each of the latter transmits the processing volume that it has processed to the third group of machines 15, for assembly and display, storage, etc. From the three-dimensional image so reconstructed, the display machine is able to display sectional views of the reconstructed image, of the surface rendering, and so on.

With the installation described in relation to FIG. 3, the data flows are controlled in an optimal manner from the sensor up to display of the reconstructed three-dimensional image.

For good flexibility of the method, it is possible, for example, to use a set of machines 13a, 13b, 13c, 14a, . . . , 14h, 15, all identical, such as 11 PC dual-processors running at 2.8 GigaHertz (GHz) for example, under the Linux operating system.

With a group of machines connected to a network with suitable data transfer rates, it is possible to configure this group of machines in the following manner:

A each machine is assigned a function in the context of the reconstruction method, such as a transmission function, a processing function, a pre-processing function, a collection and assembly function, etc. For each machine, one also designates the identity of preceding machine or machines and/or of the following machine or machines in the processing chain. Each machine then executes a given programme, which calls upon to five logic functions that are proper to the function in the reconstruction method that has to be implemented by the machine. These logic functions are:
starttreatFN, which is run once only at the initialisation of a new method,
stoptreatFN, which is executed once only in order to terminate a method,
startblockFN which is called before the processing of a data block,
stopblockFN, which is invoked to end the processing of a data block, and
treatblockFN, which is the function for processing a data block.

The library of logic functions is available locally on each machine, or over the network. It is also arranged that this method for configuring a set of machines connected in a network, in an installation that allows three-dimensional reconstruction in accordance with the method described above is implemented by software in the form of a program that can be executed on at least one of the machines of the installation.

This logical construction is used to configure a new installation easily, or to reconfigure an existing installation for a new sensor, or other. In particular, there is nothing to prevent pre-processing from then being easily executable by several machines connected in parallel in the place of either of machines 13a and 13b in the first group 13.

According to a second embodiment, shown in FIG. 4, the objective is to further reduce the number of machines intended to effect pre-processing, with the advantage of an increase in the number of processing machines. In relation to the embodiment of FIG. 3, the group of machines 13 is composed of the transmitting machine only 13c.

An acquisition machine 16 includes a real-time processor card to the “versa module eurocard” (VME) standard 17 which includes a multifunction computing core (MFCC) input/output daughter card 18 which includes a processor 19 and a field programmable gate area (FPGA) 20. The latter is plugged into one of the two PMC slots of the VME card by means of its PCI interface. The VME card 17 also includes a processor 21 and a random-access memory 22 to the PCI standard as well as a device 23 for connection to the machine 13c.

The FPGA 20 establishes the circuitry necessary for the acquisition sequences, and for initialisation of the operating parameters of the sensor.

The MFCC card 18 is connected directly to the output of the sensor 3 so that the data leaving the sensor 3 are re-organised on the fly, by passing through the FPGA, and the processor 19 applies corrective pre-processing to the data they are stored in the random-access memory 22 of the VME card 17, at a rate at least equal to 32 MB/s. Then the processor 21 carries out a last corrective processing, such as filtering, on the data stored in random-access memory, and writes the pre-processed data, via the PVIC interface 23 into the random-access memory of the machine 13c, via rapid parallel data transmission links.

If the machine 13c is temporarily overloaded, it is also possible to arrange to queue the pre-processed data in the random-access memory 22, or in a suitable buffer at the input to the machine 13c.

If necessary, it is also possible to arrange for the creation of a backup copy of the data in non-volatile memory, if it is desired to keep these data for other processing at a later time. This copy can be created on the fly on line simultaneously with the processing effected in real time.

The structure that has just been described is also extremely flexible, for applying modified pre-processing to the raw data output from the sensor, for replacing the sensor, etc., since one only has to re-program the FPGA 20 and/or processor 19 and/or processor 21 in an appropriate manner, and all by software.

1. An installation for the three-dimensional imaging of a volume to be imaged, which includes at least the following:
at least one transmitting machine (13c), designed to transmit over a network that supports transfer rates at least equal to 100 Megabits per second, intended for a multiplicity of machines for the processing of the transmitted data (10), corresponding to a projection of the said volume acquired from an incidence,
the said processing machines (14a, . . . , 14h), each designed to accept received data relating to the transmitted data,
the said received data being obtained from the data transmitted, by duplication within the network intended for each processing machine,
the said installation being designed to ensure that, for each processing machine, the received data correspond to the transmitted data,
each processing machine (14a, . . . , 14h) being designed to process the said received data in order to reconstruct a three-dimensional image of the volume to be imaged.

2. The three-dimensional imaging installation according to claim 1 in which the transmitting machine is designed to transmit the transmitted data in the form of data blocks, each with a multiplicity of datagrams, in which each processing machine is designed to transmit, to the transmitting machine, a request for re-transmission of the datagrams missing from the data block,
in which the transmitting machine is designed to list all the datagrams missing from the data block and to transmit all the datagrams missing from the data block intended for all of the processing machines.

3. The installation according to claim 1 or 2, in which each of the said processing machines (14a, . . . , 14h) is designed to perform processing of the said received data in order to reconstruct a three-dimensional image of a respective processing volume corresponding to a fraction of the volume to be imaged.

4. The installation according to claim 3, which also includes a collection machine (15), which is intended to be connected to each processing machine over the network, with the said collection machine being designed to receive the said three-dimensional images of respective processing volumes from each processing machine, and to assemble these so as to form a three-dimensional image of the volume to be imaged.

5. The installation according to any of claims 1 to 4, also including at least one pre-processing machine (13a, 13b) intended to be connected to at least one transmitting machine over the network, with the said pre-processing machine being designed to apply a pre-processing function to a projection in order to generate data to be transmitted, and to transmit the said data to be transmitted to the said transmitting machine.

6. The installation according to claim 5, in which the said pre-processing machine (13a, 13b) is designed to receive a projection from a sensor at a sensor data speed, and in which the data speed in the network is chosen in accordance with the said sensor data speed.

7. The installation according to claim 5 or claim 6, that also includes a radiation source (2) that is designed to transmit radiation in the direction of the volume to be imaged, and a sensor (3) designed to detect the said radiation after its passage through the volume to be imaged, and to generate the said projection from it.

8. The installation according to one of claims 1 to 7, in which the said machines are PC central units.

9. The installation according to one of claims 1 to 4, that includes an acquisition machine (16) with a computer (17) and a device for connection to a sensor (3) including an output delivering, to the said computer, the raw data representing a projection detected by the said sensor, where the said computer includes:
an input/output daughter card (18) that includes a pre-processing processor (19) programmed to apply pre-processing to the said raw data output from the said connection device, in order to generate pre-processed data,
a random-access memory (22), and
a bus connecting the said processing processor and the said random-access memory (22),
the said computer being designed to write to the said random-access memory the said pre-processed data coming from the processor.

10. The installation according to claim 9, in which the computer also includes:
a device for connection to the exterior, and
a processor (21) designed to read the said pre-processed data from the said random-access memory (22), to apply to them another pre-processing function in order to generate data to be transmitted, and to write the data to be transmitted into the random-access memory of a transmitting machine via the said device for connection to the exterior.

11. The installation according to claim 9 or claim 10, in which the said pre-processing processor (21) is a reconfigurable processor designed to be configured in accordance with the sensor.

12. A method for configuring a group of machines in an installation for the three-dimensional imaging of a volume to be imaged, which includes at least:
at least one transmitting machine (13c), designed to transmit, over a network that supports transfer rates at least equal to 100 Megabits per second, intended for a multiplicity of processing machines, transmitted data corresponding to a projection of the said volume acquired from a given incidence,
the said processing machines (14a, . . . , 14h) each designed to accept received data relating to the transmitted data,
the said received data, being obtained from the transmitted data by duplication within the network, intended for each processing machine,
the said installation being designed to ensure that, for each processing machine, the received data correspond to the transmitted data,
each processing machine (14a, . . . , 14h) being designed to process the said received data in order to reconstruct a three-dimensional image of the volume to be imaged,
the said configuration method including a configuration stage, in which each machine of the said group of machines is assigned to a function chosen from a group of functions that include at least a transmission function, a processing function and a reception function.

13. The configuration method according to claim 12, in which the transmission function includes a function for transmission of the transmitted data in the form of data blocks, each with a multiplicity of datagrams, in which the reception function includes a function for transmission, to the transmitting machine, of a request for re-transmission of the datagrams missing from the data block, and in which the transmission function also includes a function for listing all the missing datagrams and a function for transmission of all the missing datagrams intended for all of the processing machines.

14. The configuration method according to claim 12 or 13, in which the group of functions also includes a pre-processing function, and a collection and assembly function.

15. A computer program that includes program codes for implementation of the configuration method according to one of claims 12 to 14, when it is executed on at least one programmable machine.

16. A method for the three-dimensional imaging of a volume to be imaged 4), which includes at least:
a) a transmission stage during which at least one transmitting machine (13c) transmits, over a network that provides a transfer rate at least equal to 100 Megabits per second (Mb/s) intended for a multiplicity of processing machines, transmitted data corresponding to a projection of the said volume, acquired from a given incidence,
b) a reception stage during which each processing machine receives the received data relating to the transmitted data,
the said received data being obtained from the transmitted data by duplication within the network intended for each processing machine,
c) a checking stage during which it is ensured, for each processing machine, that the received data correspond to the transmitted data, and
d) a processing stage during which each processing machine processes the said received data in order to reconstruct a three-dimensional image of the volume to be imaged.

17. The three-dimensional imaging method according to the claim 16, in which, in the course of stage (a), the transmitting machine sends out the transmitted data in the form of data blocks, each with a multiplicity of datagrams, and
in which in the course of stage (c),
c1) each processing machine sends out, to the transmitting machine, a request for re-transmission of the datagrams missing from the data block,
c2) the transmitting machine lists all the datagrams missing from the data block, and
c3) the transmitting machine sends out all the datagrams missing from the data block intended for all of the processing machines.

18. The three-dimensional imaging method according to claim 16 or 17 in which stage (a) is repeated with other data corresponding to a projection of the said volume, and stage (a) is repeated only after a positive result from the said checking stage.

19. The three-dimensional imaging method according to claim 18, in which the stages (a) to (d) are repeated for a multiplicity of data corresponding to a multiplicity of projections of the said volume, each acquired at a given incidence, with the said incidences being distinct, two by two.

20. The three-dimensional imaging method according to one of claims 16 to 19, in which, in the course of the reception stage, in each processing machine (14a, . . . , 14h), the received data corresponding at least to a part of the said transmitted data is received,
and in which, in the course of the checking stage, each processing machine (14a, . . . , 14h) ensures that the received data correspond to the transmitted data in the following manner:
each processing machine (14a, . . . , 14h) estimates a reception quality of the received data, and sends out, in the direction of a transmission checking machine (13c), an acknowledgement of receipt relating to the reception quality of the said received data, and
the said transmission checking machine waits for the said acknowledgement of receipt from each of the processing machines.

21. The three-dimensional imaging method according to claim 20, in which the said data include a predetermined number of data datagrams,
in which, in the course of the checking stage, each processing machine (14a, . . . , 14h) sends out the said acknowledgement of receipt only after reception of the said predetermined number of datagrams.

22. The three-dimensional imaging method according to claim 21, in which in each processing machine (14a, . . . , 14h), the said transmitted data correspond to the said first received data and to unreceived data,
in which, in the course of the checking stage, the said processing machine sends out a request for re-transmission of the unreceived data, and in which, in the course of a re-transmission stage, at least the said unreceived data are re-transmitted over the said network.

23. The three-dimensional imaging method according to one of claims 16 to 22, which also includes, before the distribution stage, a stage (z) for the establishment of communications during which each processing machine (14a, . . . , 14h) sends out to the network a request to be a receiver of the distribution of the said transmitted data, the said transmitted data being duplicated within the network, in the course of the distribution stage, intended for the processing machines that have transmitted a request to be a receiver of the distribution of the transmitted data.

24. The three-dimensional imaging method according to one of claims 16 to 23, which also includes an acquisition stage (e), prior to the distribution stage, during which a sensor (3) acquires raw data corresponding to the said projection.

25. The three-dimensional imaging method according to claim 24, in which the acquisition stage is triggered in accordance with a signal transmitted by the volume to be imaged (4).

26. The three-dimensional imaging method according to claim 24 or claim 25, which also includes a pre-processing stage (f) between the said acquisition stage and the said transmission stage, during which the said transmitted data is generated by applying, to the raw data, corrective pre-processing that takes account of the physical characteristics of the acquisition.

27. The three-dimensional imaging method according to one of claims 16 to 26 in which, in the course of the processing stage, each processing machine (14a, . . . , 14h) processes a respective processing volume corresponding to a fraction of the volume to be imaged.

28. The three-dimensional imaging method according to claim 27 in which, in the course of the processing stage, each processing machine (14a, . . . , 14h) retro-projects the said received data in the said processing volume in order to obtain a three-dimensional retro-projected image corresponding to the said projection, and adds the said three-dimensional image to a prior partial result obtained from prior projections of the volume to be imaged.

29. The three-dimensional imaging method according to claim 27 or claim 28, which also includes an assembly stage (g) during which a collection machine (15) receives, from the said processing machines, the said respective processing volumes, and assembles the said processing volumes to reconstitute a three-dimensional image of the volume to be imaged.

30. A computer program that includes program codes for implementation of the three-dimensional imaging method according to one of claims 16 to 29, when it is executed on at least one programmable machine.
